(19) United States
(12) Patent Application Publication
(10) Pub. No.: US 2012/0030654 A1
(43) Pub. Date: Feb. 2, 2012

(54) APPARATUS AND METHOD FOR AUTOMATED TESTING OF SOFTWARE PROGRAM

(76) Inventors: Hong Seong Park, Seoul (KR); Jeong Seok Kang, Gochang-gun (KR); Si Wan Kim, Chuncheon-si (KR); Min Woo Ju, Chuncheon-si (KR)

(21) Appl. No.: 12/877,866

(22) Filed: Sep. 8, 2010

(30) Foreign Application Priority Data
Jul. 29, 2010 (KR) 10-2010-0073274

(51) Int. Cl. G06F 11/36

(52) U.S. Cl. 717/124

(57) ABSTRACT

Provided is an apparatus and method for automated testing of a software program. More particularly, provided is an apparatus and method for automated testing of a software program of which a source code is frequently changed. An aspect of the present invention provides an apparatus and method for automated testing of a software program that may automatically perform testing with respect to a source code file changed within a software program based on a correlation between a plurality of test objects for testing of the software program.

### CROSS-REFERENCE TO RELATED APPLICATION

This application claims the benefit of Korean Patent Application No. 10-2010-0073274, filed on Jul. 29, 2010, in the Korean Intellectual Property Office, the disclosure of which is incorporated herein by reference.

### BACKGROUND

1. Field of the Invention

The present invention relates to an apparatus and method for automated testing of a software program, and more particularly, to an apparatus and method for automated testing of a software program of which a source code is frequently changed.

2. Description of the Related Art

In general, at least 50% of total costs and about 50% of overall development time for a software program is consumed by testing operations of the software program. To decrease the above costs and development time, a tool is required to automatically process simple and repetitive test processes that are labor-intensive.

In the case of a conventional automated tool used for the software testing operations, when the conventional automated tool performs a single test, the conventional automated tool may not automatically perform other tests associated with the performed testing.

In particular, the conventional automated tool does not consider a correlation between an initially executed test and another test to be subsequently performed or a test of other dependency files. Accordingly, when a source code is changed, consecutive testing may not be performed.

### SUMMARY

An aspect of the present invention provides an apparatus and method for automated testing of a software program that may automatically perform testing with respect to a source code file changed within a software program based on a correlation between a plurality of test objects for testing of the software program.

Another aspect of the present invention also provides an apparatus and method for automated testing of a software program that may retrieve a target test object file corresponding to a changed source code file and dependency test object files associated with the target test object file, and may perform testing with respect to all of functions of a software program associated with the changed source code file.

Another aspect of the present invention also provides an apparatus and method for automated testing of a software program that may perform more accurate testing using a test solution and a test project file. Here, the test solution may indicate a related structure between a target test object and dependency test objects. The test project file may include a test case file and a source code file corresponding to each of the target test object and the dependency test objects.

According to an aspect of the present invention, there is provided an apparatus for automated testing of a software program, including: a test correlation table to store a correlation between test objects for testing of the software program; a test solution processor to retrieve, from the test objects based on the correlation, a target test object corresponding to a changed source code file of the software program and dependency test objects associated with the target test object when the source code file is changed, and to create a test solution using the retrieval result; and a test project processor to compile and execute a source code file corresponding to each of the retrieved target test object and the dependency test objects.

According to another aspect of the present invention, there is provided a method of automated testing of a software program, including: creating a correlation between test objects for testing of the software program; detecting a change in a source code file within the software program; retrieving, from the test objects, a target test object corresponding to the changed source code file of the software program when the change is detected; retrieving dependency test objects associated with the target test object based on the correlation; and compiling and executing a source code file corresponding to each of the retrieved target test object and the dependency test objects.

According to embodiments of the present invention, testing may be readily performed with respect to a system where a source code is frequently changed. In particular, it is possible to perform automated testing by detecting a change in a source code file within a software program.

Also, according to embodiments of the present invention, it is possible to perform testing with respect to all of functions of a software program associated with a changed source code file. In addition, more accurate testing may be performed.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a configuration of a system employing an automated software program testing method according to an embodiment of the present invention;

FIG. 2 illustrates an example of a test solution created by an automated software program testing method according to an embodiment of the present invention;

FIG. 3 illustrates an example of a test project created by an automated software program testing method according to an embodiment of the present invention;

FIG. 4 illustrates an automated software program testing method according to an embodiment of the present invention;

FIGS. 5A and 5B illustrate an example of a structure between a target test object and dependency test objects in an automated software program testing method according to an embodiment of the present invention; and

FIG. 6 illustrates state information of a test object compiled and executed in an automated software program testing method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

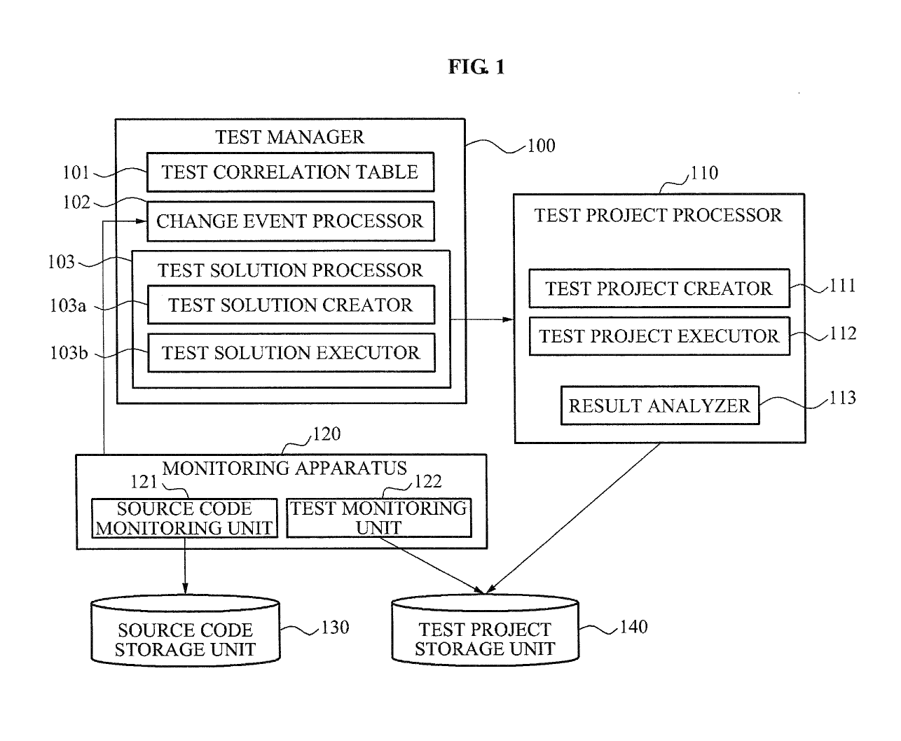

FIG. 1 illustrates a configuration of a system employing an automated software program testing method according to an embodiment of the present invention.

The system may include a test manager 100, a test project processor 110, a monitoring apparatus 120, a source code storage unit 130, and a test project storage unit 140.

The test manager 100 may create a correlation between test objects for testing a software program. When a target test object to be tested exists, the test manager 100 may select dependency test objects associated with the target test object based on the created correlation, and may automatically perform testing with respect to the target test object and the dependency test objects.

When a source code or a test project of the software program is changed, the test manager 100 may select a test object associated with the changed source code or test project based on the correlation, and may automatically perform testing with respect to the selected test object. Hereinafter, a set of the target test object and the dependency test objects is referred to as a “test solution”. An initial performance unit of the test is referred to as a “test project”.

The test manager 100 may include a test correlation table 101, a change event processor 102, and a test solution processor 103.

The test correlation table 101 may store a correlation between test objects corresponding to the source code of the software program. The correlation may be provided in a tree structure including an upper node and a lower node.

The change event processor 102 may interoperate with the monitoring apparatus 120 configured to monitor the source code storage unit 130 and the test project storage unit 140. Accordingly, the change event processor 102 may recognize a change in files that are stored in the source code storage unit 130 and the test project storage unit 140. For example, the change event processor 102 may detect whether the stored files are created, changed or deleted, based on a change event input from the monitoring apparatus 120. Also, the change event processor 102 may request the test solution processor 103 to initiate an operation depending on whether a change in a file stored in the source code storage unit 130 is detected.

In response to a user input or the request from the change event processor 102, the test solution processor 103 may retrieve dependency test objects associated with the target test object to be tested, by referring to the test correlation table 101, and may create a test solution based on the retrieval result. The test solution processor 103 may request the test project processor 110 for testing of the target test object and the dependency test objects using the test solution.

The test solution processor 103 may include a test solution creator 103a and a test solution executor 103b.

The test solution creator 103a may check an execution order of each test object and dependency files based on the test correlation table 101, and may retrieve dependency test objects associated with the target test object. The test solution creator 103a may create the test solution indicating an associated structure between the target test object and the dependency test objects using the retrieval result.

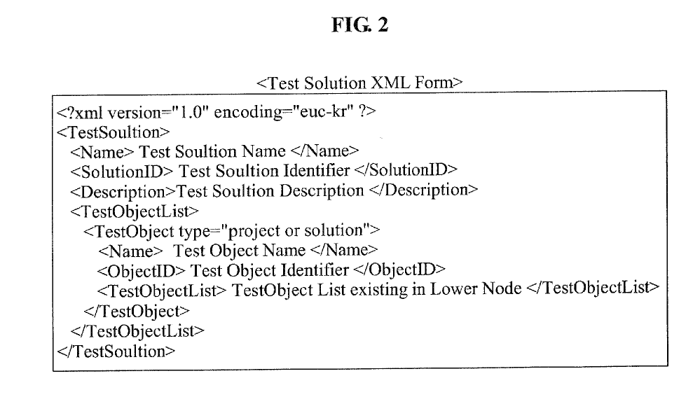

A data file of the created test solution may be expressed as shown in FIG. 2.

FIG. 2 illustrates an example of the data file of the test solution configured as an eXtensible Markup Language (XML) file. The data file of the test solution may include a name “Name” of the test solution, an identifier “SolutionID” of the test solution, description information “Description” of the test solution, and a list “TestObjectList” of test objects constituting the test solution. The plurality of test objects may include a target test object and dependency test objects associated with the target test object. Here, the plurality of test objects “TestObject” within the list “TestObjectList” may have upper and lower concepts such as an upper node and a lower node in a tree structure, or may be another test project or another test solution.

The test solution executor 103b may insert, into a test execution queue, the target test object and the dependency test objects in a designated order based on the created test solution. The test solution executor 103b may request the test project processor 110 to execute the inserted test objects. Here, the designated order may be an order from the lower node to the upper node.

The test project processor 110 may create a test project for testing of a test object requested to be executed by the test solution executor 103b, and may perform and analyze the created test project.

The test projector processor 110 may include a test project creator 111, a test project executor 112, and a result analyzer 113.

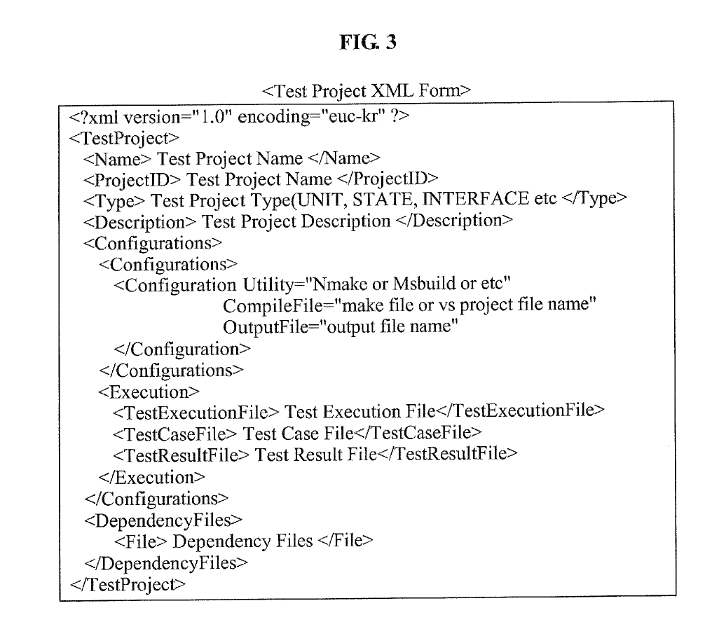

The test project creator 111 may create the test project based on various test types, for example, a unit test, a state test, an interface test, and the like. The test project may be expressed as shown in FIG. 3.

FIG. 3 illustrates an example of the data file of the test project configured as an XML file. The data file of the test project may include a name “Name” of the test project, an identifier “ProjectID” of the test project, a test project type “Type”, description information “Description”, configuration information “Configurations” for compiling or executing the test project, and a source code “DependencyFiles” associated with the test project.

The test project executor 112 may perform testing with respect to a test object requested to be executed based on the created test project. For example, the test project executor 112 may compile the source code “DependencyFiles” using a testing scheme based on “Type”, on the basis of the data file of the created test project.

The result analyzer 113 may analyze a test log file and a result file created according to an execution result of the test project, and may determine whether the testing is successful. Also, when the testing is successful, the result analyzer 113 may store and update the data file of the test project in the test project storage unit 140.

The monitoring apparatus 120 may periodically monitor a change in files that are stored in the source code storage unit 130 and the test project storage unit 140. The source code storage unit 130 may store a source code file of the software program. The source code file may be corrected, deleted, or added to by a developer. The test project storage unit 140 may store the data file of the test project created by the test project processor 110.

The monitoring apparatus 120 may include a source code monitoring unit 121 and a test monitoring unit 122.

The source code monitoring unit 121 may monitor whether the source code files stored in the source code storage unit 130 are changed, and may inform the change event processor 102 about a change in a source code file detected by monitoring.

The test monitoring unit 122 may monitor whether data files of the test project stored in the test project storage unit 140 are changed, and may inform the change event processor 102 about a change in data files of the test project detected by monitoring.

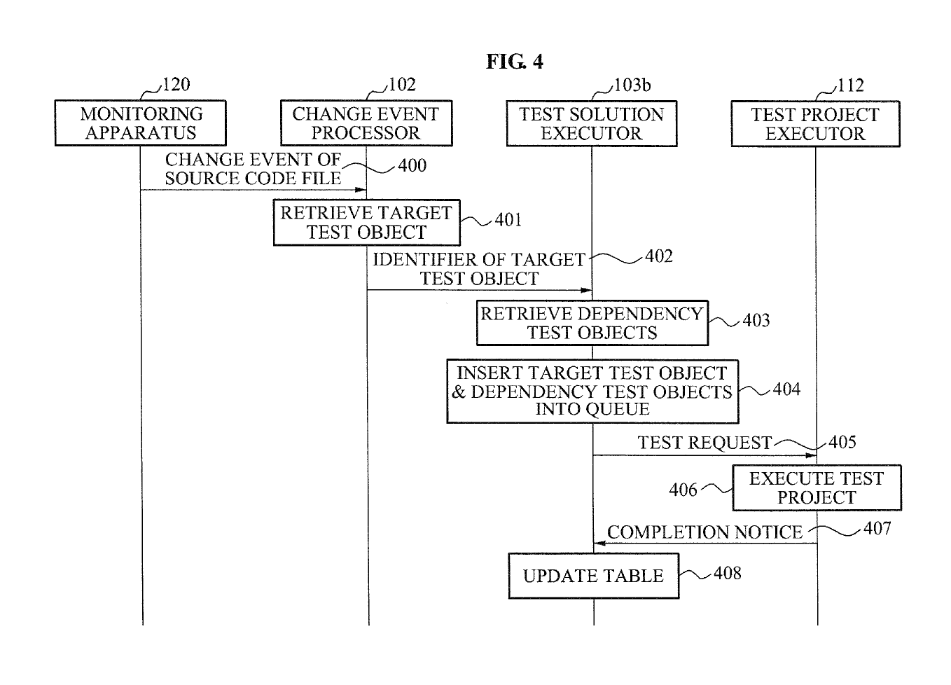

FIG. 4 illustrates an automated software program testing method according to an embodiment of the present invention.

Referring to FIG. 4, in operation 400, a monitoring apparatus 120 may detect a change in a source code, for example, “DeFile.cpp”, stored in a source code storage unit, and may inform a change event processor 102 about the detected change in the source code.

In operation 401, the change event processor 102 may retrieve a target test object associated with the changed source code, based on a test correlation table.

In operation 402, an identifier of the retrieved target test object may be transferred to a test solution executor 103b.

In operation 403, the test solution executor 103b may retrieve dependency test objects associated with the identifier of the target test object based on the test correlation table, using the identifier of the target test object. Also, in operation 403, the test solution executor 103b may create a test solution using the retrieval result. Here, a data file of the created test solution may include a name “Name” of the test solution, an identifier “SolutionID” of the test solution, description information “Description”, and a list “TestObjectList” of the target test object and the dependency test objects constituting the test solution.

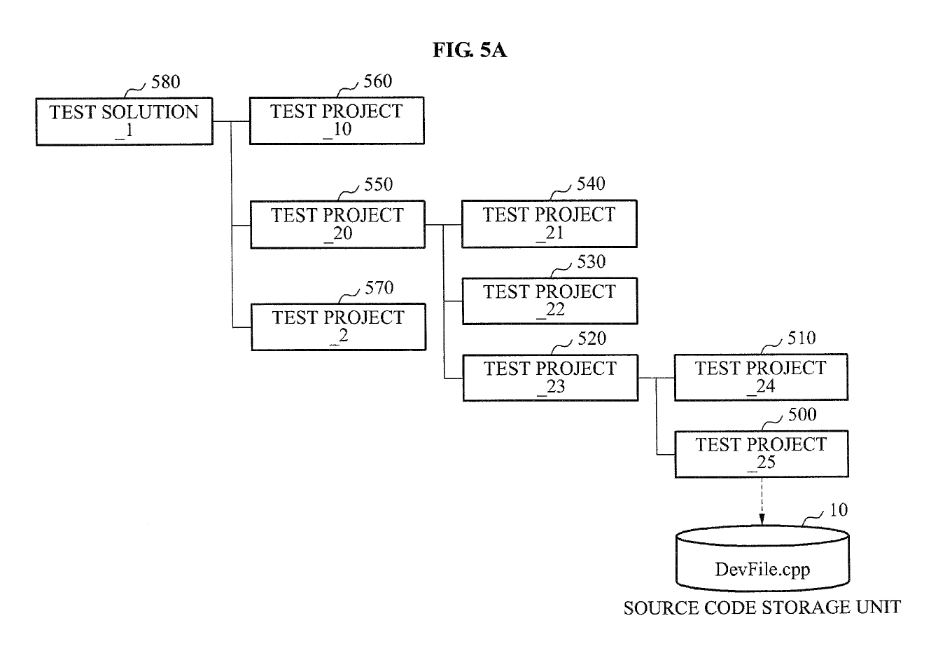

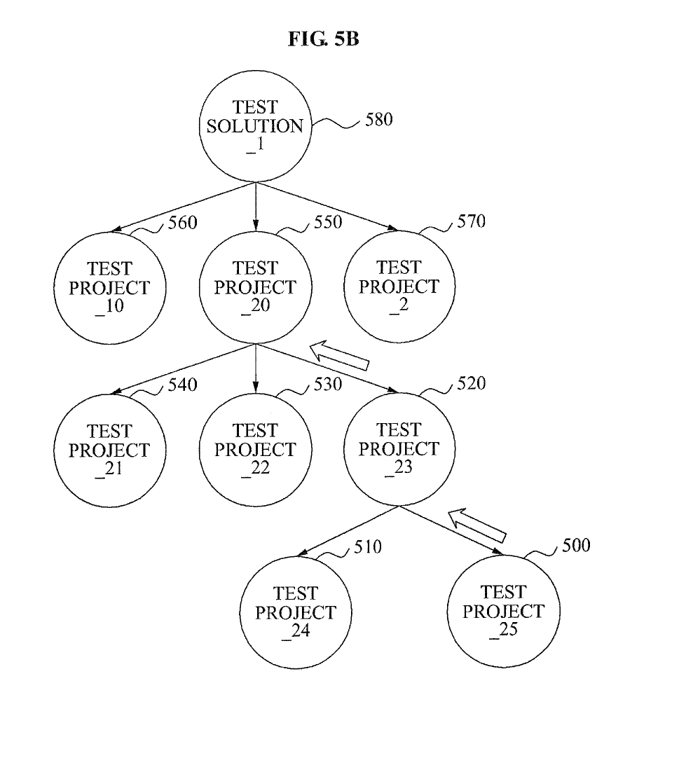

The list within the test solution may be expressed as shown in FIG. 5A and FIG. 5B, and may show a structure between the target test object and the dependency test objects.

Referring to FIG. 5A, a target node 500 indicates a target test object corresponding to a changed source code 10. Other nodes 510, 520, 530, 540, 550, 560, 570, and 580 indicate dependency test objects associated with the target test objects. All the nodes 510, 520, 530, 540, 550, 560, 570, and 580 of FIG. 5A are arranged based on an execution order.

Also, as shown in FIG. 5B, the above arrangement may be expressed in a material structure of a tree form. FIG. 5B shows a process of retrieving upper nodes, that is, the nodes 520, 550, and 580 of the target node 500 and other lower nodes, that is, the nodes 510, 530, 540, 560, and 570 of the upper nodes, that is, the nodes 520, 550, and 580 when the target node 500 is retrieved.

In operation 404, the test solution executor 103b may insert, into a test queue, the target test object and the dependency test objects in a designated order. For example, in operation 404, the target test object and the associated objects may be inserted into the test queue in an order from an upper node to a lower node in the tree structure.

In operation 405, the test solution executor 103b may request a test project executor 112 for testing of the inserted test objects.

In operation 406, the test project executor 112 may execute a test project corresponding to each of the test objects requested to be tested. Specifically, in operation 460, the test project executor 112 may compile and execute a source code associated with a corresponding test project based on a data file of the test project.

In operation 407, the test project executor 112 may inform the test solution executor 103b about the completion of execution and the change.

In operation 408, the test solution executor 130b may update the test correlation table based on the change.

For sequential compiling and execution of the test objects requested to be tested, state information associated with each of the test objects may be used in operation 406. Specifically, in operation 406, state information of a test object of which compiling and execution is ongoing may be changed to RUNNING. When the compiling and execution is completed, the state information of the test object may be changed to FINISHED.

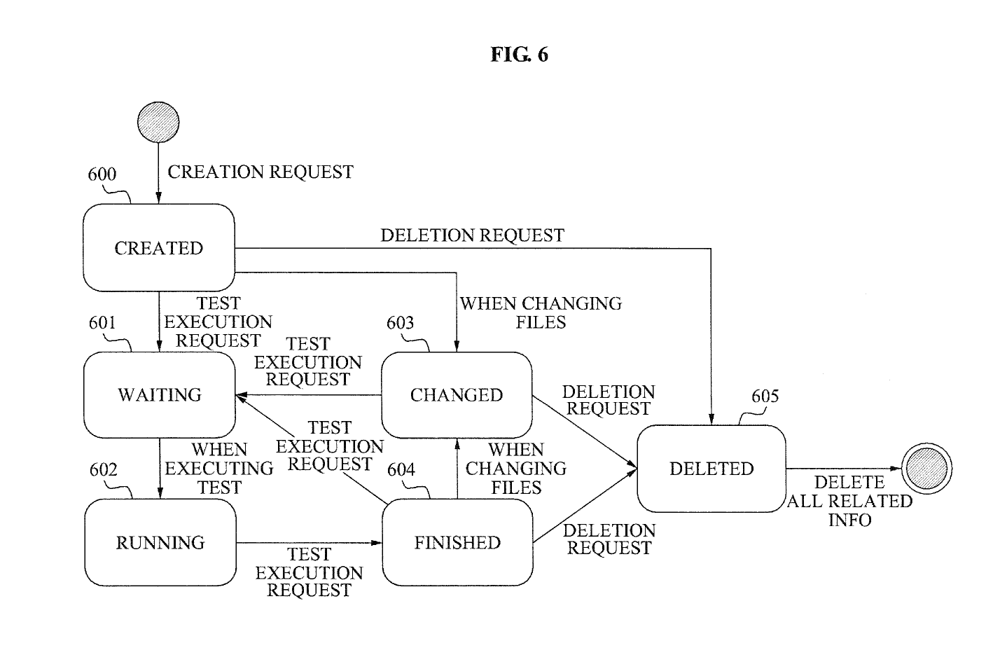

FIG. 6 illustrates state information of a test object of which compiling and execution is ongoing in an automated software program testing method according to an embodiment of the present invention.

Referring to FIG. 6, the state information may include CREATED, WAITING, RUNNING, FINISHED, CHANGED, and DELETED. Each state may be defined as the following Table 1:

TABLE 1

| State | Description |
|---|---|
| CREATED | A state where a test project or a test solution is created |
| WAITING | A waiting state for executing the test project or the test |
| | solution |
| RUNNING | A state where the test project or the test solution is being |
| | executed |
| FINISHED | A state where the execution of the test project or the test |
| | solution is completed |
| CHANGED | A state where a dependency test object or a file associated |
| | with a storage unit (a developer source code or a test project |
| | file) is changed |
| DELETED | A state where the test project or the test solution is being |
| | deleted |

Specifically, prior to executing testing of a software program, an apparatus for automated testing of the software program test may create a plurality of test objects with respect to a source code of the software program, and may create a correlation between the plurality of test objects. Here, state information associated with the test objects may be set to “CREATED” 600. Next, when testing with respect to a portion of the test objects is requested, state information of test objects requested to be tested may be set to “WAITING” 601. The test objects requested to be tested may be sequentially tested based on an order inserted into a test queue. The state information of the test objects of which testing is ongoing may be set to “RUNNING” 602. The state information of the test objects of which testing is completed may be set to “FINISHED” 604. When a test object to be changed or be deleted due to the executed test exists, state information of the test object to be changed or be deleted may be set to “CHANGED” 603 or “DELETED” 605. The state information may be informed to a test solution executor.

The above-described exemplary embodiments of the present invention may be recorded in non-transitory computer-readable media including program instructions to implement various operations embodied by a computer. The media may also include, alone or in combination with the program instructions, data files, data structures, and the like. Examples of program instructions include both machine code, such as produced by a compiler, and files containing higher level code that may be executed by the computer using an interpreter.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An system for automated testing of a software program, comprising:
a test correlation table to store a correlation between test objects for testing of the software program;
a test solution processor to retrieve, from the test objects based on the correlation, a target test object corresponding to a changed source code file of the software program and dependency test objects associated with the target test object when the source code file is changed, and to create a test solution using the retrieval result; and
a test project processor to compile and execute a source code file corresponding to each of the retrieved target test object and the dependency test objects.

2. The apparatus of claim 1, wherein the test solution processor comprises:
a test solution creator to create a test solution indicating a related structure between the target test object and the dependency test objects, when the dependency test objects are retrieved; and
a test solution executor to request testing in a designated order with respect to the target test object and the dependency test objects based on the test solution.

3. The apparatus of claim 2, wherein the test solution executor requests the test in an order from a lower node to an upper node with respect to the target test object and the dependency test objects based on a structure of the test solution.

4. The apparatus of claim 2, wherein the test project processor comprises:
a test project creator to retrieve at least one of a source code file and a test case file corresponding to each of the target test object and the dependency test objects, and to create a test project file including the retrieval result;
a test project executor to compile and execute the source code file corresponding to each of the target test object and the dependency test objects based on the created test project file; and
a result analyzer to analyze the compilation and execution result of the test project executor.

5. The apparatus of claim 1, wherein the test projector processor manages state information associated with each of the target test object and the dependency test objects, and sequentially tests the target test object and the dependency test objects based on the state to information.

6. A method of automated testing of a software program, comprising:
creating a correlation between test objects for testing of the software program;
detecting a change in a source code file within the software program;
retrieving, from the test objects, a target test object corresponding to the changed source code file of the software program when the change is detected;
retrieving dependency test objects associated with the target test object based on the correlation; and
compiling and executing a source code file corresponding to each of the retrieved target test object and the dependency test objects.

7. The method of claim 6, further comprising:
creating a test solution indicating a related structure between the target test object and the dependency test objects, when the dependency test objects are retrieved; and
requesting testing in a designated order with respect to the target test object and the dependency test objects based on the test solution.

8. The method of claim 7, wherein the requesting of the testing comprises requesting the test in an order from a lower node to an upper node with respect to the target test object and the dependency test objects based on a structure of the test solution.

9. The method of claim 6, wherein the compiling and the executing comprises:
retrieving at least one of a source code file and a test case file corresponding to each of the target test object and the dependency test objects;
creating a test project file including the retrieval result; and
to compiling and executing a source code file corresponding to a test object for which the test is requested based on the created test project file, using a test case file associated with the test object.

10. The method of claim 6, further comprising:
managing state information associated with each of the target test object and the dependency test objects,
wherein the compiling and the executing comprises sequentially compiling and executing source code files corresponding to the target test object and the dependency test objects based on the state information.
